(19) United States
(12) Patent Application Publication
(10) Pub. No.: US 2004/0209130 A1
(43) Pub. Date: Oct. 21, 2004

(54) Fuel cell anode gas oxidizing apparatus and process

(75) Inventor: Vladimir Lifshits, Redwood City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Coen Company, Inc., Burlingame, CA

(21) Appl. No.: 10/826,558

(22) Filed: Apr. 16, 2004

Related U.S. Application Data
(60) Provisional application No. 60/464,220, filed on Apr. 18, 2003.

(51) Int. Cl. H01M 8/00; H01M 8/04; H01M 8/10; H01M 8/12; H01M 8/18

(52) U.S. Cl. 429/13; 429/17; 429/19; 429/26

(57) ABSTRACT

Heat is extracted from an oxidizable component in an anode gas generated by a fuel cell. A heat exchanger is in fluid communication with the fuel cell, and the anode gas flows through a first portion of the heat exchanger. The heat exchanger is further in fluid communication with a source of an oxygen-containing gas, such as air, and has a second portion through which the air flows, so that the temperatures of the anode gas and the oxygen-containing gas tend to equalize in the heat exchanger. A downstream end of the heat exchanger is in fluid communication with a space where the anode gas and the air mix and form a mixture of anode gas and air. A first burner located upstream of the heat exchanger heats the air. A catalytic oxidizer is in fluid communication with the space and oxidizes the mixture. The catalytic oxidizer emits a heated effluent that is directed back to the fuel cell. A second burner heats the effluent during at least portions of the time during the operation. An anode gas buffer evens out short-duration spikes in the concentration of oxidizable components.

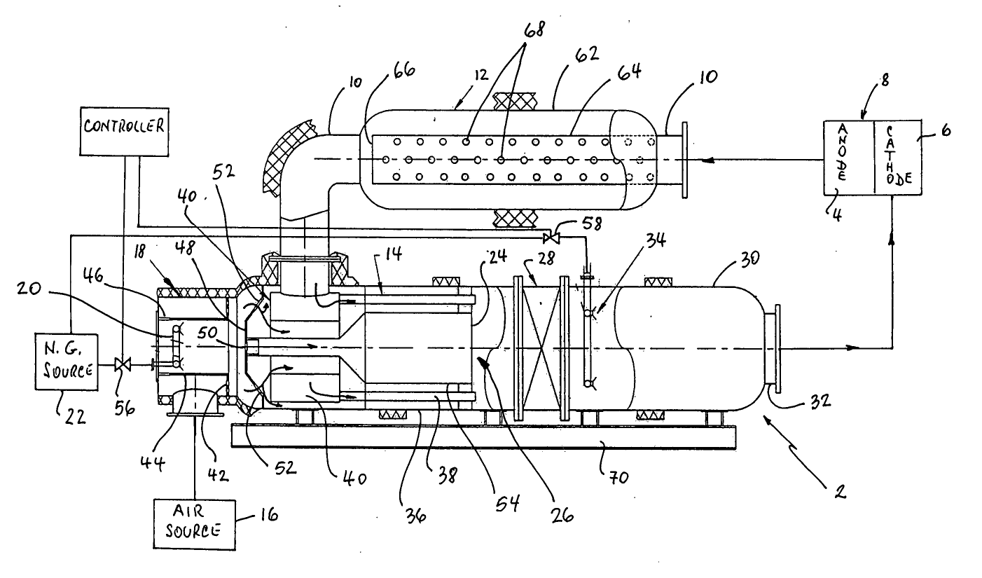

### BACKGROUND OF THE INVENTION

This invention relates to an apparatus and method for extracting and using the heat value of oxidizable components or products in the gas generated at the anode side of a fuel cell and providing additional heat that may be necessary for maintaining the minimum required fuel cell temperature.

Fuel cells are a desirable source of electric power which can be generated from different hydrogen-containing substances like natural gas, for example, in a substantially pollution-free manner. The present invention is particularly well suited for use with relatively large stationary fuel cells such as power plants having a generating capacity ranging from as little as a fraction of a megawatt to several megawatts.

To properly operate the fuel cell, it must first be heated with an external source of heat at least during its initial start-up phase and at times thereafter when heat generated by the reactions inside the fuel cell itself is insufficient for sustaining of the process.

Gas exiting the anode side of a fuel cell contains a substantial amount of hydrogen (H₂) and carbon monoxide (CO). These components vary from several percentage points to as much as 50% of the anode gas. After being mixed with air these components can be combusted catalytically to generate useable heat. Additional fuel, like natural gas, can also be introduced in the system and combusted for supplying needed heat when the concentration of H₂ and/or CO is low, or these gases are not present at all, for example during the fuel cell warm-up.

The composition and temperature of anode gas from fuel cells can vary over wide ranges during normal operation of the fuel cell. When mixed with air, the mixture is not immediately homogeneous. Instead, portions of the anode gas form flammable and not flammable pockets of micro mixtures. The temperature of such pockets of flammable mixture can rise above the auto-ignition temperature of the combustible components, which can lead to instantaneous micro explosions creating rapid pressure pulsations, and/or combustion instabilities, all of which are detrimental to the equipment, including the fuel cell. Controlling the flammability conditions during the mixing process is complicated by the fact that changes in the composition and flow of the anode gas can be abrupt, for example, when there are sudden changes in the power demand placed on the fuel cell.

The most critical operating conditions typically arise when there are abrupt changes in the anode gas composition towards a high H₂ content. Increased concentrations of H₂ decrease the auto-ignition temperature of the mixture. At the same time, the peak temperatures in the mixing space may remain unchanged due to the thermal inertia of system elements before changes leading to temperature reduction of the mixture can be effected.

The present invention is directed to a particularly efficient method and apparatus for controlling the oxidation of the combustible product in the anode gas from fuel cells and supplying heat to the fuel cell when needed.

### SUMMARY OF THE INVENTION

The present invention eliminates the formation of pockets in the anode gas/air mixture that may auto-ignite, while assuring that the temperature of the overall mixture flowing to the catalytic reactor is sufficient to commence and thereafter maintain the catalytic oxidation process, irrespective of the composition and/or temperature of the anode gas. It also minimizes the peak temperature inside the catalytic reactor, which makes it possible to construct the anode gas oxidation and recirculation apparatus of less costly materials that require less maintenance over their lives, thereby reducing the installation as well as operating costs. At the same time it greatly improves reliability of the system and components thereof by making them less sensitive to the abrupt changes in the process that are encountered from time to time.

Thus, one aspect of the present invention is directed to a method of operating fuel cells by passing the anode gas through a heat exchanger and transferring some of its physical heat to combustion air used for heating the air that is then mixed with the anode gas so that the peak temperature in the mixing zone is below the auto-ignition temperature of the fuel components while the average bulk mixed temperature is sufficient to initiate the catalytic oxidation.

Another aspect of the present invention relates to heating the combustion air and gas downstream of the catalytic reactor with two spaced-apart heaters or burners. A first, front burner fires in the flow of combustion air upstream of the heat exchanger at a rate necessary to raise the temperature upstream of the catalytic reactor to the minimum required temperature, which will sustain the oxidation process. A second, after burner provides additional heat if the temperature of the effluent exiting the catalytic reactor is insufficient for normal fuel cell operation.

In a preferred embodiment of the invention, the anode gas and the air flow through a heat exchanger where their respective temperatures tend to equalize. The temperature of the anode gas can be as high as about 1200°-1300° F. (approximately 650°-705° C.) or more, a temperature that may be above the auto-ignition temperature of the combustible components in the gas. Such high temperature anode gas if mixed immediately with air can form pockets in the mixture that can lead to the earlier mentioned, undesirable auto-ignition of portions of the mixture. The amount of air passing through the heat exchanger is typically several times more than the flow of anode gas, and the initial temperature of the air is as low as ambient temperature. As a result, the average bulk mixed temperature as well as peak temperature of the flow downstream of the heat exchanger are always well below the auto-ignition temperature of about 800°-1000° F. (approximately 427°-538° C.). When the mixed temperature of air and anode gas resulting from physical heat of the gas coming from the fuel cell anode is insufficient for the catalytic reactor operation, the front burner fires fuel, such as natural gas. The heat from this combustion raises the air temperature so that the bulk or average mixed temperature just upstream of the catalytic reactor is maintained at a minimum of about 300°-500° F. (approximately 140°-260° C.), which is sufficient for the catalytic oxidation.

In the catalytic oxidizer or reactor, the oxidizable or combustible components in the anode gas are oxidized, which raises the temperature of the effluent from the catalytic reactor to as high as 1000°-1400° F. (approximately 538°-760° C.) for supplying heat to the fuel cell.

Since the temperature of the effluent will vary according to the composition and temperature of the anode gas, it is at least sometimes necessary to add heat to the effluent in order to raise its temperature to the level required for heating and initiating and/or continuing the operation of the fuel cell. For this purpose, a second heater, preferably also a natural gas heater, heats the effluent at least during portions of the operation of the fuel cell, such as during its start-up phase.

By placing the second heater downstream of the catalyzer, the heat input required from the first heater, located upstream of the heat exchanger, can be reduced, thereby reducing the overall temperature of the anode gas-air mixture upstream of the oxidizer, which in turn permits the use of less heat-resistant material for the construction of the oxidizer and reduces initial installation as well as operating costs.

The present invention additionally provides an apparatus for carrying out the above-described method. Such an apparatus has a heat exchanger that is in fluid communication with and receives anode gas from the anode side of the fuel cell. The heat exchanger is further in fluid communication with a source of oxygen-containing gas, typically air, so that the temperatures of the anode gas and the (preheated) air tend to become more equalized before they are discharged into a mixing space from where they flow to the catalyzer. The discharge side of the catalyzer is in fluid communication with the cathode side of the fuel cell, where the effluent from the catalyzer is used to heat the fuel cell during its start-up phase as well as whenever operating conditions require additional heat input to the fuel cell.

When fuel cells are subjected to short-duration changes in the demand for electricity, such as when the fuel cell suddenly encounters no electrical load, short-duration spikes in the flammable components in the anode gas are often encountered. This can lead to short-duration drops in the auto-ignition temperature and auto-ignition in the mixture downstream of the heat exchanger, and the like. Such short-duration spikes in the flammable components may be difficult and/or costly to overcome, considering that such upset conditions may require selecting a larger heat exchanger, for example, that achieves a higher degree of temperature equalization between the air and anode gas. To prevent such spikes in the flammable components of the anode gas from adversely affecting the operation of the system and/or to help prevent the formation of auto-igniting pockets in the mixture, an anode gas buffer can additionally be placed upstream of the heat exchanger where the flow of the anode gas in a relatively larger volume of anode gas can be continuously mixed over a longer time. This reduces the adverse effects that can be caused by sudden spikes in the flammable components of the anode gas and enhances the operation and safety of the system.

### BRIEF DESCRIPTION OF THE DRAWINGS

The single drawing schematically shows a fuel cell anode gas oxidizer constructed in accordance with the present invention.

### DETAILED DESCRIPTION OF THE INVENTION

Referring to the drawing, a fuel cell anode gas oxidizer 2 constructed in accordance with the invention is placed between an anode side 4 and a cathode side 6 of a fuel cell 8. An anode gas inlet conduit 10, which may include an anode gas buffer 12 (further described below), leads from the fuel cell to an upstream side of a heat exchanger 14. The heat exchanger is in fluid communication with a source of air 16 via an air conduit 18 which includes a first, upstream heater 20 that heats the air, preferably with natural gas from a natural gas source 22.

The anode gas and air flow through heat exchanger 14, where their temperatures become more equalized before they are discharged from a downstream side 24 of the heat exchanger into a mixing space 26 where the air and anode gas form a mixture. The mixture flows to and through a catalytic reactor or oxidizer 28 where the combustible components of the anode gas are oxidized, thereby heating the mixture. The mixture flows from the oxidizer through an exit mixing chamber 30 and a return conduit 32 to the cathode side 6 of the fuel cell. A gas heater 34 located downstream of oxidizer 28 is provided for heating the effluent from the oxidizer (as is further described below) before the effluent is returned to the fuel cell.

In the preferred embodiment illustrated in the drawing, the heat exchanger is defined by an outer conduit 36 and a substantial number of heat exchange pipes 38 which are arranged relatively closely to the outer conduit but spaced therefrom. In a preferred embodiment, the outer conduit has a cylindrical configuration, and the heat exchange pipes are arranged along a concentric circle radially inwardly of the outer conduit. Both heat exchange pipes 38 and conduit 36 may have extended surfaces (not shown). The downstream ends of the heat exchange pipes are open (and may include directional anode gas discharge nozzles, not separately shown, to facilitate mixing), and the upstream ends are fluidly connected to a bustle or manifold 40 that is in fluid communication with anode gas inlet 10. Thus, the anode gas flows in a downstream direction through the pipes and is discharged from the open ends thereof into mixing space 26.

Air conduit 18 includes a perforated baffle wall 42 joined to a downstream end of an inner tubular shield 44 which surrounds upstream heater 20. Openings 46 in the tubular shield are provided for flowing at least some of the air to be heated past the heater. While some of the required air flows through openings 46 past heater 20, additional air may bypass the heater and flow directly past the baffle wall through the perforations in the annular portion of the wall between tubular shield 44 and air conduit 18.

Air flowing directly through the baffle wall and air heated by heater 20 impinge on a convexly shaped plate 48 located some distance downstream of baffle wall 42 to approximately equalize the temperature of the air, which then flows through outwardly located openings 52 in plate 48 past manifold 40 and into heat exchanger 14, as is illustrated by the flow arrows in the drawing. A tubular core 54 extends concentrically along the heat exchanger from a downstream side of plate 48 to about the downstream end of heat exchange pipes 38 diverting the air flow passing through openings 52 toward the tubes 38. A minor amount of purging air also flows through a central opening 50 to inside the tubular core 54.

As a result, the temperature of the normally much hotter anode gas (which may be as high as 1000°-1300° F. (approximately 538°-705° C.)) and the relatively cooler ambient or heated air passing through openings 52 exchange heat between each other to thereby lower the temperature of the former and raise the temperature of the latter so that they become more equal before their discharge into the mixing space. This reduces the temperature of the combustible components in the anode gas, such as H₂, and helps prevent the formation of high temperature pockets in the mixture that could auto-ignite, as was discussed above.

The output of upstream heater 20 is adjusted so that the average temperature of the mixture in space 26 upstream of the oxidizer is within the desired range, typically between about 300°-500° F. (approximately 140°-260° C.). Depending on the operating conditions, that may require a correspondingly larger or lesser amount of heat output from the upstream heater, or no heat at all.

In the otherwise conventional catalytic reactor 28, the combustible components of the mixture are oxidized, thereby raising the temperature of the effluent from the oxidizer as compared to the temperature of the mixture downstream thereof. During the start-up phase of the fuel cell, and thereafter as needed, downstream heater 34 heats the effluent to the desired temperature for heating the cathode side of the fuel cell to its operating temperature, typically in the range between about 1000°-1400° F. (approximately 538°-760° C.). To assure a homogeneous temperature of the effluent, exit mixing chamber 30 is preferably interposed between the upstream side of heater 34 and return conduit 32.

An advantage of the present invention is that two heaters, upstream heater 20 and downstream heater 34, are provided instead of only a single upstream heater, as in the past. This makes it easier to regulate the temperatures of the mixture to optimize the operation of the catalytic oxidizer 28 and the oxidation of the combustible products in the anode gas. Similarly, downstream heater 34 can be operated to give the effluent the temperature needed for optimizing the operation of the fuel cell. To attain this, the heat output of the two burners is independently modulated.

For this purpose, first and second valves 56, 58 are placed in the natural gas supply lines for the upstream air heater 20 and the downstream heater 34 for the effluent from the oxidizer. The valves are preferably operated via a controller 60 that is suitably integrated with the other controls (not shown) for the anode gas oxidizer of the present invention so that, for example, sudden changes in the amount of combustible products in the anode gas can be substantially instantaneously compensated for by correspondingly modulating one and/or the other one of natural gas control valves 56, 58.

To moderate the influence (and potentially adverse effects) of sudden changes in the amount of combustible product in and/or the temperature of the anode gas, buffer 12 can be interposed in anode gas inlet 10. There are multiple ways for configuring the buffer. For example, the buffer can be formed by an enlarged diameter vessel 62 and a distribution tube 64 which extends from an upstream end of the vessel to the vicinity of the downstream end thereof. The distribution tube has a closed end 66 and a relatively large number of radial openings 68 distributed over its length. As a result, a volume of gas entering the tube which has a relatively high content of combustible products does not flow directly to the heat exchanger and into the mixing space. Instead, it is diffused into the interior of the buffer vessel, where its residence time is increased so that it can mix with anode gas that was previously discharged by the fuel cell and that may have a relatively lesser amount of combustible materials. As a result, the proportion of combustible products in the anode gas which flows to the heat exchanger is lowered, and the undesirable side effects from spikes in the content of combustible products, such as H₂, are significantly moderated. This in turn lessens the need for modulating the gas supply valve(s) and helps prevent the formation of auto-igniting hot spots in the mixture being formed in mixing space 26.

By virtue of its self-contained and independent construction, the anode gas oxidizer of the present invention is ideally suited for use with fuel cells that are operated at remote locations. It can be mounted, for example, on a pallet 70 for ease of transportation even to remote areas where it can be operated to provide electricity that would otherwise not be available.

What is claimed is:

1. A method for operating a fuel cell that generates an anode gas including oxidizable components comprising receiving the anode gas from the fuel cell at an elevated temperature, adding oxygen to the anode gas to form an oxidizable anode gas mixture, heating the oxygen when a temperature of the mixture drops to below a temperature at which the combustible components can be catalytically oxidized to thereby give the mixture a temperature at which the combustible materials catalytically oxidize, catalytically oxidizing the mixture to form an effluent, thereafter heating the effluent during at least portions of the time when the fuel cell generates electricity, and heating the fuel cell with the effluent.

2. A method according to claim 1 wherein heating comprises generating an air flow, heating the air flow, and thereafter mixing the air flow with the anode gas to form the mixture.

3. A method according to claim 2 including exchanging heat between the air flow and the anode gas prior to mixing the air flow with the anode gas.

4. A method according to claim 3 wherein exchanging heat comprises forming first and second flow paths for the anode gas and the air flow and separating the flow paths by a heat exchange medium to transfer heat between the anode gas and the air flow so that the temperatures of the anode gas and the air flow become more equal, and thereafter merging the anode gas and the air flow to form the mixture.

5. A method according to claim 4 including selecting a length of the flow paths so that substantially no portions of the mixture are above an auto-ignition temperature of the combustible components in the anode gas at a predetermined highest temperature of the anode gas encountered during the operation of the fuel cell.

6. A method according to claim 1 including modulating a heat output that is generated for heating the anode gas to compensate for variations in at least one of the temperature of the anode gas and a proportion of the combustible components in the anode gas.

7. A method according to claim 6 including independently modulating the heat output during heating the oxygen and a heat output generated for heating the effluent.

8. A method according to claim 1 including buffering the anode gas prior to adding oxygen to compensate for fluctuations in at least one of the proportion of combustible components in the anode gas and a temperature of the anode gas.

9. A method of operating a fuel cell which generates an anode gas that includes an oxidizable component comprising flowing the anode gas through a first flow path of a heat exchanger having first and second flow paths separated by a heat exchange member, directing an air flow through the second flow path of the heat exchanger, heating the air flow upstream of the heat exchanger, permitting a heat exchange between the anode gas and the air flow in the first and second flow paths to thereby decrease a temperature differential between the anode gas and the air flow, thereafter mixing the anode gas and the air flow downstream of the flow paths to form a mixture, directing the mixture through a catalytic oxidizer for oxidizing the oxidizable component in the anode gas and generating heat, flowing an effluent from the catalytic oxidizer to the fuel cell, and at least at times during the operation of the fuel cell heating the effluent from the catalytic oxidizer before the effluent reaches the fuel cell.

10. A method according to claim 9 including selecting a heat input to the air flow and a length of the first and second flow paths so that substantially all portions of the mixture downstream of the flow paths have a temperature that is below an auto-ignition temperature of the oxidizable component in the anode gas.

11. A method according to claim 10 wherein heating comprises heating the air flow sufficiently to maintain a temperature of the mixture at which the oxidizable component of the anode gas oxidizes in the catalytic oxidizer.

12. A method according to claim 11 wherein heating is performed intermittently.

13. Apparatus for continuously operating a fuel cell and extracting heat from an oxidizable component in an anode gas generated by the fuel cell comprising a heat exchanger in fluid communication with the fuel cell for flowing the anode gas through a first portion of the heat exchanger, the heat exchanger being further in fluid communication with a source of an oxygen-containing gas and having a second portion through which the oxygen-containing gas flows, whereby the temperatures of the anode gas and the oxygen-containing gas tend to equalize in the heat exchanger, a downstream end of the heat exchanger being in fluid communication with a space where the anode gas and the oxygen-containing gas mix and form a mixture of anode gas and oxygen-containing gas, a first burner located upstream of the heat exchanger for heating the oxygen-containing gas, a catalytic oxidizer in fluid communication with the space receiving and oxidizing the mixture, the catalytic oxidizer emitting a heated effluent, a conduit for directing at least a portion of the heated effluent from the catalytic oxidizer back to the fuel cell, and a second burner for heating the effluent during at least portions of the time when the fuel cell is operating.

14. A heat exchanger according to claim 13 including a controller that independently modulates a heat output generated by the first and second burners.

15. Apparatus according to claim 13 wherein the heat exchanger comprises first and second parallel conduits.

16. Apparatus according to claim 15 wherein the heat exchanger comprises an outer tubular member extending in the flow direction of the oxygen-containing gas and a plurality of spaced-apart pipes extending generally parallel to the tubular member and having openings proximate downstream ends of the pipes which are in fluid communication with the space, one of the tubular member and the pipes being in fluid communication with the oxygen-containing gas flow downstream of the first burner and the other one of the tubular member and the pipes being in fluid communication with the fuel cell for receiving the anode gas so that the mixture is formed in the space after the temperature differential between the anode gas and the oxygen-containing gas has been reduced to thereby prevent the formation of auto-igniting hot spots in the mixture.

17. Apparatus according to claim 16 wherein the pipes are arranged proximate an outer wall of the tubular member.

18. Apparatus according to claim 17 including a deflector in the flow of the oxygen-containing gas located upstream of the pipes for directing the oxygen-containing gas radially outward towards the pipes arranged proximate the outer wall of the tubular member.

19. Apparatus according to claim 13 wherein the source is a source of air.
